(19) United States
(12) Patent Application Publication
(10) Pub. No.: US 2011/0193039 A1
(43) Pub. Date: Aug. 11, 2011

(54) Motorcycle lift dolly

(76) Inventors: Rodney Dean Brakhage, Stillwater, OK (US); Aaron Edward Zimmermann, Blue Ridge, TX (US)

(21) Appl. No.: 12/930,402

(22) Filed: Jan. 6, 2011

Related U.S. Application Data
(60) Provisional application No. 61/335,446, filed on Jan. 7, 2010.

(51) Int. Cl. B66F 3/00

(52) U.S. Cl. 254/8 R

(57) ABSTRACT

A device for lifting and moving motorcycles and other objects comprises a dolly having a base and plural wheels supporting the base; a support means for lifting and supporting at least one side of a motor vehicle, the support means being hingedly connected to the dolly such that the support means can pivotally rotate from a position parallel with the base to a position beyond that which is perpendicular to the base; the support means further comprising a support frame which stays generally parallel with the base as the support means pivotally rotates, the support frame disposed at the end of the support means opposite from the hinged connection to the dolly; the support means further comprising a stop means for preventing the support means from rotating past a predetermined angle to the base; and a crank seat disposed on a side of the support means whereby a crank can be inserted into the crank seat to turn the support means about its hinged axis.

### CROSS-REFERENCES TO RELATED APPLICATIONS

The present application claims the benefit of 35 U.S.C. section 111(b) provisional application Ser. No. 61/335,446, filed Jan. 7, 2010, and entitled “Motorcycle Lift Dolly”.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO A SEQUENCE LISTING

Not applicable.

### BACKGROUND OF THE INVENTION

1. Field of the Invention

This invention relates to the field of motorcycle lift dollies and to devices which can lift and move relatively heavy vehicles and other devices.

2. Description of the Related Art

Motorcycles and similar vehicles are often too heavy or bulky to easily move when their engine is off. It is desirable to provide a dolly on which the motorcycle of similar vehicle can be placed to facilitate easier movement. Repair shops and motorcycle owners who do their own servicing or work on the motorcycle need a dolly to easily move the motorcycle.

It is advantageous for a motorcycle dolly to support the motorcycle from underneath, so that the motorcycle rests on both the dolly and one of the tires. With the motorcycle's transmission placed in neutral, the rear wheel and tire will freely turn. The motorcycle can be easily moved upon the free-turning rear wheel and the dolly wheels. The front wheel and tire of the motorcycle will not touch the ground or floor while on the dolly. If the motorcycle's rear wheel is not touching the floor, the front wheel will rest on the floor. If the motorcycle's rear wheel is resting on the floor, the front wheel will not touch the floor.

It is not easy to lift a heavy motorcycle up onto a dolly. Therefore, it would be advantageous if the dolly combined a means for easily lifting a motorcycle into position on the dolly. The motorcycle must be capable of being stably supported while the lifting process takes place and then while the motorcycle rests upon the dolly and is moved about on the dolly.

### BRIEF STATEMENT OF THE INVENTION

This invention is a novel device which combines both a dolly and a lifting mechanism. The invention comprises a low wheeled dolly platform having a lifting mechanism mounted atop the platform. The lifting mechanism comprises a support means for supporting a motorcycle, the support means attached to at least one arm that is hingedly attached to the top side of the dolly platform. The support means is rotatable around the hinged attachment to the dolly platform. The arm(s) are capable of rotating from a position generally horizontal up to and some way beyond the vertical, so that the rotation of the arm(s) is limited to an angle lying between 95 degrees and 135 degrees. Stop means prevent the arm(s) from rotating beyond the desired position where the motorcycle will stably rest on the lifting mechanism. The lifting mechanism may have a means for adjusting the height of the lifting mechanism so as to accommodate motorcycles having various ground clearances (street bikes versus dirt bikes). A detachable crank can be used to lift the lifting mechanism.

This invention can comprise a dolly having a base and plural wheels supporting the base; a support means for lifting and supporting at least one side of a motor vehicle, the support means being hingedly connected to the dolly such that the support means can pivotally rotate from a position parallel with the base to a position beyond that which is perpendicular to the base; the support means further comprising a support frame which stays generally parallel with the base as the support means pivotally rotates, the support frame disposed at the end of the support means opposite from the hinged connection to the dolly; the support means further comprising a stop means for preventing the support means from rotating past a predetermined angle to the base; and a crank seat disposed on a side of the support means whereby a crank can be inserted into the crank seat to turn the support means about its hinged axis.

The invention may further comprise an extension means for extending the support frame on the support means. The plural wheels of the dolly may be sized such that the base lies below the axis of the plural wheels.

### BRIEF DESCRIPTION OF THE DRAWINGS

FIG. 1 is a perspective view of the preferred embodiment of the motorcycle lift dolly of this invention showing the crank and height adjustment rings separately.

FIG. 2 is a perspective view of the preferred embodiment of the motorcycle lift dolly of this invention showing the support means removed from the arms.

FIG. 3 is a perspective view of the preferred embodiment of the motorcycle lift dolly of this invention showing the support means and two sets of height adjustment rings inserted into the arms, with the crank inserted into the support means (turned to lower the lifting mechanism) and with the lifting mechanism in its up position such as it would be when supporting a motorcycle.

FIG. 4 is a perspective view of the preferred embodiment of the motorcycle lift dolly of this invention, absent the height adjustment rings, showing the crank inserted in the support means in the position to raise the lifting mechanism up and with the lifting mechanism in its up position such as it would be when supporting a motorcycle.

FIG. 5 is perspective view of the preferred embodiment of the motorcycle lift dolly of this invention, absent the height adjustment rings, showing the crank inserted in the support means in the position to lower the lifting mechanism and with the lifting mechanism in its up position.

FIG. 6 shows a simplified side view of the preferred embodiment of this invention showing the lifting mechanism in its fully down or horizontal position.

FIG. 7 shows a simplified side view of the preferred embodiment of this invention showing the lifting mechanism in a semi-raised position such that it just begins to contact the underside of a motorcycle.

FIG. 8 shows a simplified side view of the preferred embodiment of this invention showing the lifting mechanism in the up position somewhat beyond the vertical such as it would be when supporting a lifted motorcycle.

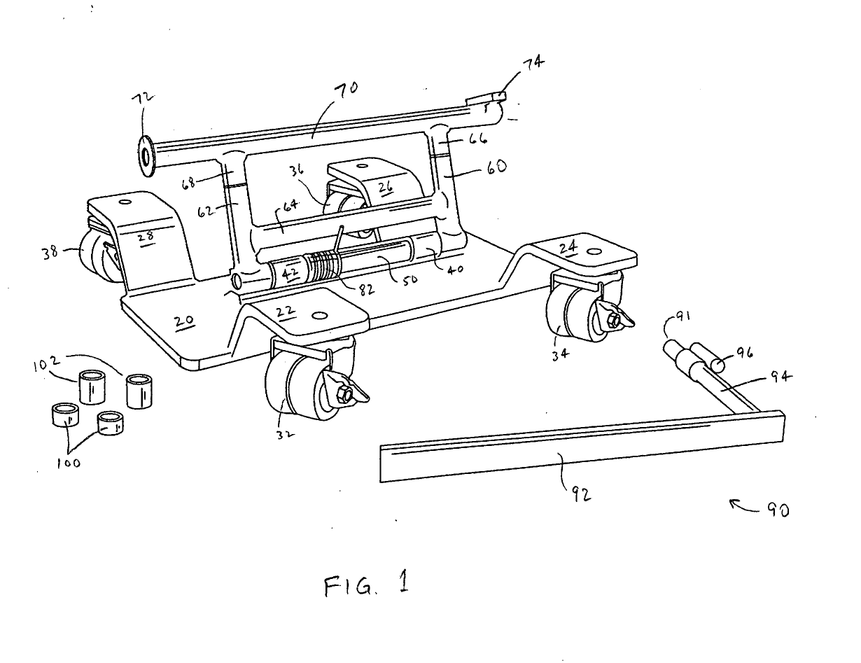

### DESCRIPTION OF THE PREFERRED EMBODIMENT

A preferred embodiment of this invention is shown in the drawing figures. The preferred embodiment comprises a dolly platform 10 having a central generally rectangular plate 20 with four support legs 22, 24, 26, and 28, one leg disposed generally at each of the four corners of the plate. The exact number and disposition of the legs is not critical but disposing them generally at the four corners of the rectangular plate maximizes stability and strength as will be apparent to a person of ordinary skill in this art. The legs are each attached to a particular side of the rectangular plate. Each leg may be angled generally upwards from its attachment to an intermediate line at which the leg is angled in a manner generally parallel to the ground or floor. The particular arrangement of the legs is not critical to this invention; persons of ordinary skill in this art will be able to devise different designs which accomplish the purposes of the legs shown in the drawings.

At least one wheel is pivotally attached to each leg. The wheels 32, 34, 36, and 38 all roll about their individual axes, and are also capable of pivoting about the vertical axis so that the dolly can be easily moved in any direction. A common wheel truck with one or more wheels per truck may be used. One or more of the wheel trucks may comprise a brake mechanism that enables that wheel to be locked in a non-rolling state. The combination of the rectangular plate 20 and the four legs 22, 24, 26, and 28, and wheels 32, 34, 36, and 38 comprises the dolly. The combination is arranged so that the rectangular plate 20 is relatively low to the ground or floor, but not so low that it might scrape the ground or floor as it moves. Preferably, the top of the rectangular plate 20 will lie below the axes of the four wheels for maximum stability.

It will be apparent to a person of ordinary skill in this art that the use of a rectangular plate 20 is not critical to this invention. A square or round or triangular plate could be used. The platform 10 need not be a plate. The wheels could be integral to the platform or on separate legs. Any platform which is suitably stable and which can roll with relative ease could be substituted for the rectangular plate described in this preferred embodiment and still lie within the inventive concept disclosed here.

The preferred embodiment further comprises a lifting mechanism 30 attached to the top side of the dolly platform 10. Preferably, it will be centrally disposed on the dolly platform 10, but its exact location is not critical.

The lifting mechanism 30 comprises one or more hinge tubes, each hinge tube attached to the top of the rectangular plate. The hinge tubes are relatively short tubes. The axes of the tubes are aligned and oriented in the direction of the longer dimension of the rectangular plate. In the preferred embodiment, there are two hinge tubes 40 and 42.

A pivot bar 50 is disposed through each of the hinge tubes 40 and 42 so that the pivot bar 50 can rotate within the hinge tubes 40 and 42. At least one arm is attached to the pivot bar. In the preferred embodiment, there are two arms 60 and 62 attached to the pivot bar. The arm extends away from the pivot bar. There may be a strength bar 64 attached between the two arms shown in the figures. The two arms 60 and 62 and the strength bar 64 generally form an “H”. The pivot bar 50 and the two arms 60 and 62 may be tubes or solid bars or any other suitable form.

In the preferred embodiment, the arms 60 and 62 are tubes with open female ends opposite the connections of the arms 60 and 62 to the pivot bar 50.

The combination of the hinge tube(s), the pivot bar, and the arms forms a hinge wherein the arms pivot around the axis of the hinge tubes and pivot bar.

The lifting mechanism 30 further comprises a means for supporting a motorcycle. In the preferred embodiment, this is shown as a support bar 70 that is attached to the ends of the arms apart on the side of the arms away from their attachment to the pivot bar 50. The support bar 70 may be longer than the pivot bar 50. The support bar 70 may have a stop ring 72 attached to a first side of the support bar 70 to prevent the motorcycle from slipping off of that side. The support bar 70 preferably has a female opening 71 at the second end which is opposite from the first end. That female opening in the support bar 70 may simply be the interior of the support bar 70 if the support bar is a tube rather than a solid bar. If the support bar 70 is a solid bar, then it may have a female opening drilled into the end.

On the second end of the support bar 70, where there is the female opening, there is a stop bar 74 attached to the exterior end of the second end of the support bar. This stop bar 74 will be utilized with the crank as will be explained below. The stop bar 74 may be a unitary part of the support bar 70, it may be welded to the support bar 70, it may be bolted or riveted to the support bar 70, or it may be attached in any other suitable fashion.

The combination of the hinge tubes 40 and 42, the pivot bar 50, the arms 60 and 62, and the support bar 70 comprise the basic elements of lifting mechanism 30. The lifting mechanism 30 is intended to rotate about the hinge tubes 40 and 42. But its rotation may be limited to somewhere between 95 degrees and 135 degrees from horizontal (or 5 degrees to 45 degrees from vertical). The lifting mechanism's rotation will extend all the way to the horizontal on a first side of the axis of the hinge tubes 40 and 42, so that it lies generally parallel with the rectangular plate 20 of the dolly on one side of the hinge tubes. The lifting mechanism's rotation will extend up from the horizontal on the first side of the axis of the hinge tubes, up to and at least slightly beyond the vertical. How much beyond the vertical on the side opposite the first side of the hinge tubes' axis is a matter of design choice. But, generally, the limit would normally be chosen to be from 5 degrees to 45 degrees from the vertical. The person of ordinary skill in this art will see the need for maximizing both height and stability of the motorcycle. As long as the rotation has significantly passed the vertical, the weight of the motorcycle will prevent the support bar 70 from going again to the first side of the hinge tubes' axis without significant force being applied to make that happen.

In order to limit the rotation of the lifting mechanism on the second side of the hinge tubes' axis, there is a rotation stop bar 80 attached to the lifting mechanism on the side of which rotation is to be limited. This is the second side of the axis of the hinge tubes 40 and 42. The manner in which the rotation stop bar's exact location is a matter of design choice. In the preferred embodiment, it is attached to the two arms 60 and 62. As the arms 60 and 62 rotate over beyond the vertical, the rotation stop bar 80 comes into contact with the top of the rectangular plate 20 and prevents the arms 60 and 62 from rotating further around the axis of the hinge tubes 40 and 42.

The lifting mechanism 30 is urged to the second side of the axis of the hinge tubes and to the horizontal position by a spring means 82 wound around the pivot tube 50 between the hinge tubes 40 and 42, and butted up against the strength bar 64. The spring means 82 is oriented so as to help lift the lifting mechanism up from its horizontal position toward the vertical position.

A crank 90 can be used to move the lifting mechanism up from the horizontal position and over past the vertical position when a motorcycle is placed over the dolly. The crank 90 comprises a relatively long lever bar 92 with a crank bar 94 attached generally at one end and extending at an approximately 90-degree angle to the lever bar 92. The crank rod 94 constitutes a male portion that will be placed into the female opening 71 in the end of the support bar 70. The crank rod 94 will also have a stop bar 96 attached to it at a point somewhat up the end 91 of the crank rod 94 that first enters the female opening. After the crank rod 94 slides some distance into the female opening 71 in the support bar 70, a portion with greater diameter will stop further entry. The crank 90 is then turned so as to rotate the crank rod 94 within the female opening 71 of the support bar 70. As the crank 90 is so rotated, its stop bar 96 will contact the rotation stop bar 74 on the support bar 70, thus preventing further rotation of the crank relative to the support bar 70. Any further rotation of the crank 90 in the same direction will cause the lifting mechanism 30 to rotate around its hinge tubes 40 and 42, lifting the lifting mechanism 30 up to and beyond the vertical, thereby lifting the motorcycle up off one of its wheels and stably supporting its' underside. It is apparent to persons of ordinary skill in this art that, with a crank 30 having a lever bar 92 of sufficient length, even the heaviest of motorcycles can be lifted up off the ground on the support bar 70 of the lifting mechanism 32 by even relatively weak persons.

In the preferred embodiment, the crank 90 is designed as a separate piece that can be inserted into and removed from the motorcycle dolly. It is possible to design the crank so that it is an integral part of the dolly and that embodiment would come within the scope of this invention.

The various elements of the dolly 10 and lifting mechanism 30 of this preferred embodiment, except for the wheels 32, 34, 36, and 38 of the dolly, will preferably be made of metal. Any suitable metal can be used such as steel, stainless steel, iron, aluminum, brass, or the like. However, it is possible to make any or all parts of thermoplastic, PVC, wood, or any other material that is suitably strong and rigid. The wheels can be made of rubber or thermoplastic or any other suitable material.

The manner by which the various elements of this embodiment are attached is not critical. The attachment between the rectangular plate 20 and the legs, the attachment between the rectangular plate 20 and the hinge, and the attachment between the arms 60 and 62 and the support means 70 can each be accomplished in multiple ways. Any such attachment could be a welded connection, a bolted or riveted connection, an adhesively attached connection, or any other suitable means for attaching the elements that is sufficiently sturdy and inexpensive.

### Height Adjustment

The lifting mechanism may be constructed so that its height is not adjustable. However, the preferred embodiment has a means for adjusting the distance between the pivot bar 50 and the support means 70. This will then enable the adjustment of the height of the support bar when it is in its up position holding a motorcycle.

Height adjustment is accomplished by providing inner arms 66 and 68 extending from the support means 70 which mate with and are inserted into the arms 60 and 62 respectively. Inner arms 66 and 68 are either integral with the support means 70 or are securely attached to it. The combination of the support means 70 and the inner arms 66 and 68 can then be easily inserted into the female openings of arms 60 and 62 before the dolly is placed under the motorcycle to lift it. The support means may be secured to the arms by inserting a common cotter pin or screw into a small hole drilled into the side of one of the arms 60 and 62 and through one of the inner arms 66 and 68. Once the inner arms are placed into the arms and the holes aligned, the cotter pin can be inserted. It may be necessary to have multiple holes for differing heights.

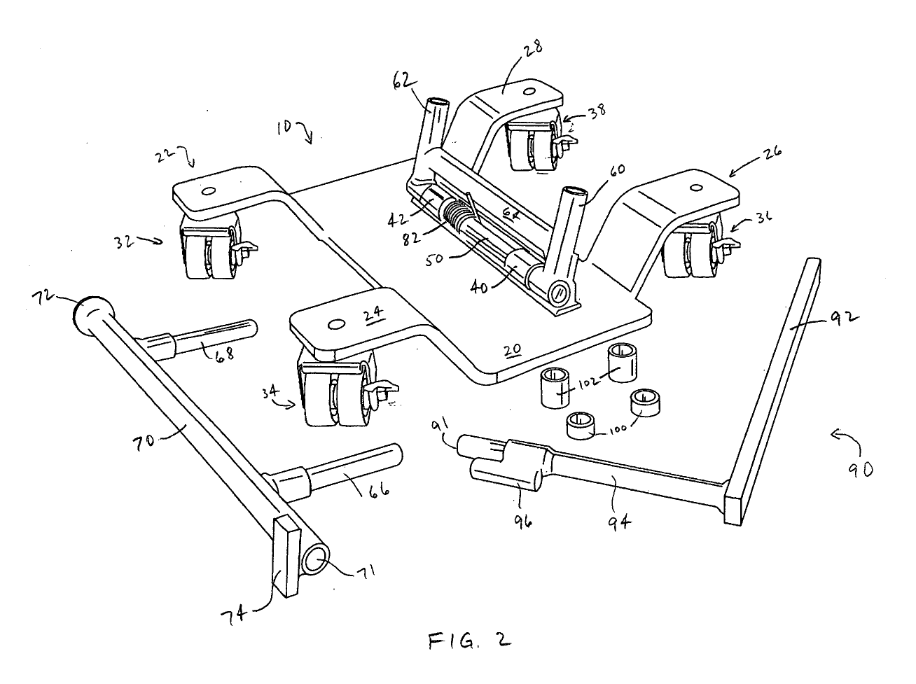

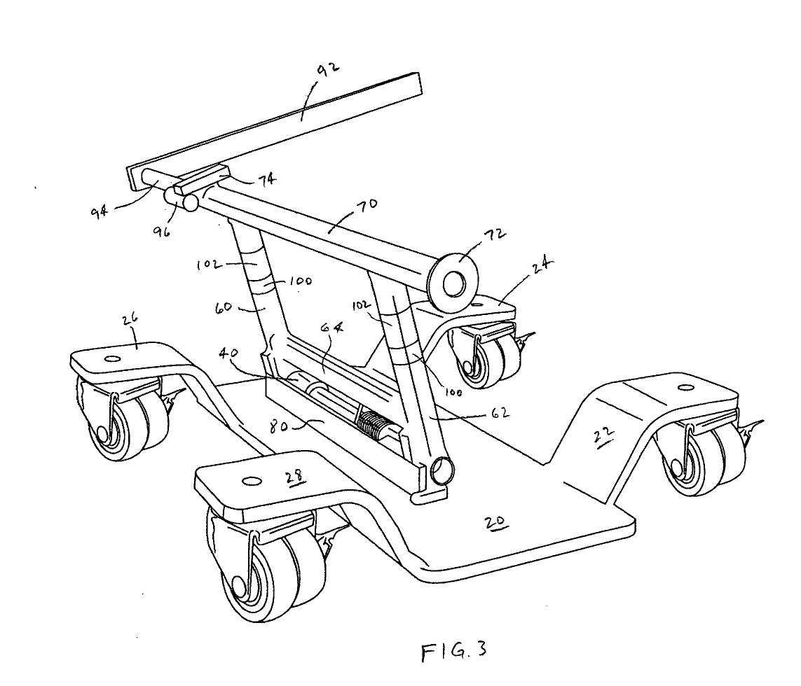

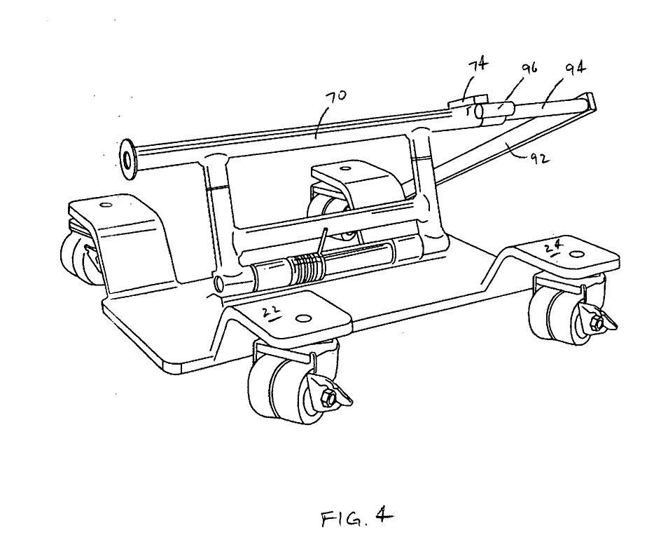

To adjust the height of the support means 70, one can provide two rings of a particular length and place one ring over each of the inner arms before the inner arms are placed into the female openings of the arms 60 and 62. Several sets of rings may be provided, each set of two rings having a different length, thereby providing the lifting mechanism with different heights depending on which set of rings is used. FIG. 2 shows two sets of two rings each 100 and 102 dismounted from the arms. FIG. 3 shows the support means 70 inserted into the arms 60 and 62 with set 100 of short rings and set 102 of longer rings inserted respectively in each arm. The person of ordinary skill in this art will easily see how different sets of rings could be used to adjust the distance between the pivot bar 50 and the support means 70. Any number of sets of height adjustment rings of any size could be utilized. The length of inner arms 66 and 68 and arms 60 and 62 can be chosen to accommodate any desired length.

### Operation

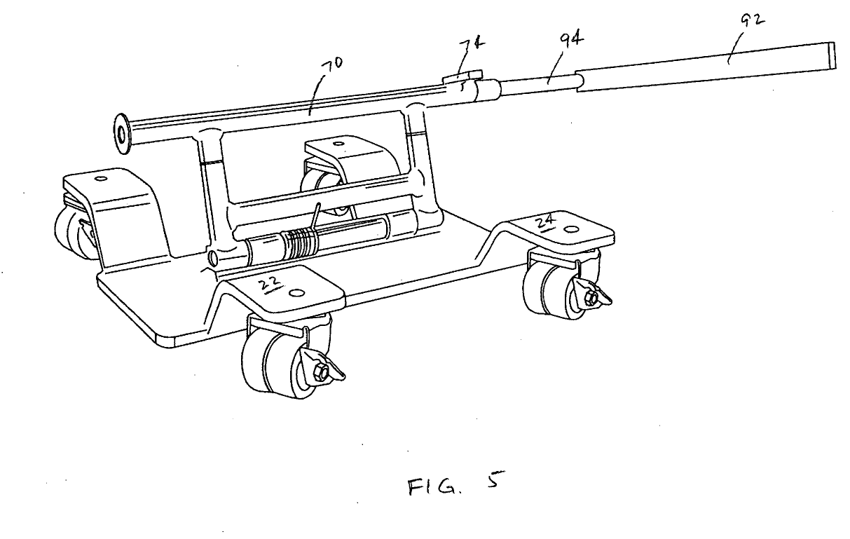

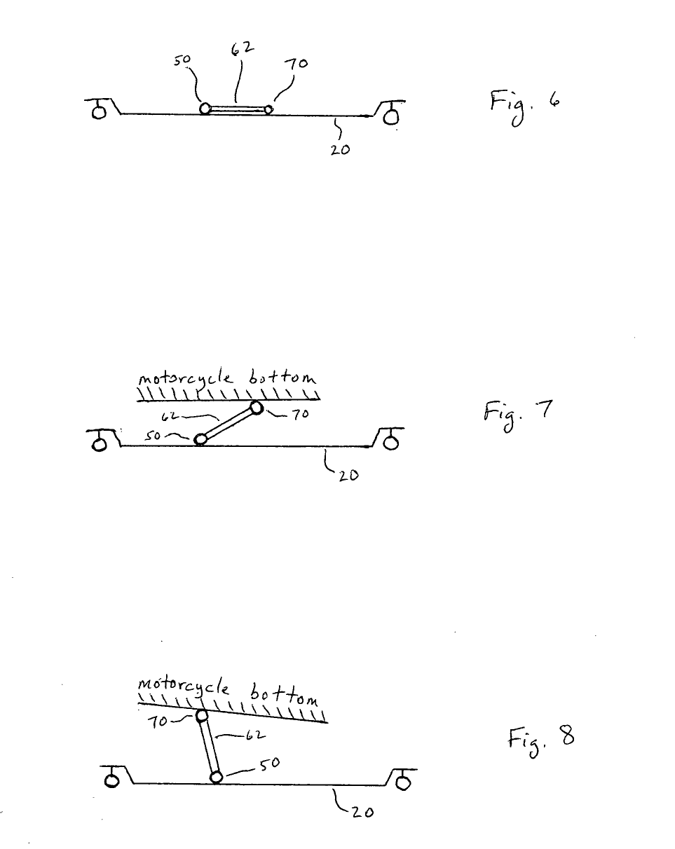

In operation, the motorcycle dolly will operate in the following manner. A motorcycle to be lifted will rest on its two wheels on the ground or floor. Its kickstand will be down. The dolly will have its lifting mechanism down in the horizontal position, as shown in FIG. 6. The dolly will be rolled beneath the motorcycle between the two wheels and under the engine. It will be oriented so that the support bar is perpendicular to the alignment of the motorcycle's wheels (that is, in the direction that the motorcycle would travel if rolled on its wheels). The wheels of the dolly are now preferably locked into position so that the dolly does not move when the lifting mechanism is lifted with the crank. Then the crank is inserted into the lifting mechanism and a person pulls back on the crank causing the lifting mechanism to come up from the horizontal position to where it begins to contact the bottom of the motorcycle, as is shown in FIG. 7. To this point, pulling back on the crank requires relatively little effort from the person; the spring means 82 actually urges the lifting mechanism 30 up to this position. Now, as the person pulls the crank further, more effort is required. Pulling on the crank causes the lifting mechanism to lift the motorcycle up slightly as the arms of the lifting mechanism come to the vertical. Continuing to pull on the crank, the arms of the lifting mechanism go beyond the vertical to a position slightly inclined in the other direction, at which time the stop bar contacts the rectangular plate of the dolly and prevents the arms from rotating any further in the direction they have been rotating. This position is shown in FIG. 8. The motorcycle now sits securely atop the support bar and on one of its wheels. The person can unlock the dolly's wheels if the motorcycle is to be moved. With little effort, the person can now push the motorcycle along the ground or floor, causing it to roll on the one wheel contacting the ground and on the wheels of the dolly. The person may remove the crank from the lifting mechanism if desired.

To take the motorcycle off of the dolly, one reinserts the crank if necessary, locks the wheels of the dolly if necessary, and then pulls the crank in the opposite direction as when the motorcycle was lifted. This pulls the arms of the lifting mechanism back to the vertical and then over to the other side. As the arms rotate back away from the vertical, the motorcycle is gently lowered to the point where both wheels touch the ground. The spring or the person will cause the arms to move back to the horizontal position. The wheels of the dolly can then be unlocked and the dolly moved out from under the motorcycle. The motorcycle then rests on its own two wheels. The motorcycle's kickstand can be put in the down position or a person can mount the motorcycle to ride it.

The preferred embodiment has been described as having particular elements, not all of which are critical to the practice of this invention. Persons of ordinary skill in this art who read this disclosure will be able to design certain modifications of the preferred embodiment which will come within the scope of this invention. Other modifications of the preferred embodiment may be equivalents of it, or contain elements that are equivalent to elements of the preferred embodiment. All such equivalents and modifications are considered to fall within the scope of this invention, which is not limited to the preferred embodiment.

I claim:

1. An apparatus comprising:
1) a dolly having a base and plural wheels supporting the base;
2) a support means for lifting and supporting at least one side of a motor vehicle, the support means being hingedly connected to the dolly such that the support means can pivotally rotate from a position parallel with the base to a position beyond that which is perpendicular to the base;
3) the support means further comprising a support frame which stays generally parallel with the base as the support means pivotally rotates, the support frame disposed at the end of the support means opposite from the hinged connection to the dolly;
4) the support means further comprising a stop means for preventing the support means from rotating past a predetermined angle to the base; and
5) a crank seat disposed on a side of the support means whereby a crank can be inserted into the crank seat to turn the support means about its hinged axis.

2. The apparatus of claim 1 further comprising an extension means for extending the support frame on the support means.

3. The apparatus of claim 1 wherein the plural wheels of the dolly are sized such that the base lies below the axis of the plural wheels.

4. The apparatus of claim 1 where the predetermined angle is an angle between 95 degrees and 135 degrees relative to the base.
